(19) United States
(12) Patent Application Publication
(10) Pub. No.: US 2024/0301187 A1
(43) Pub. Date: Sep. 12, 2024

(54) POLYPROPYLENE COMPOSITION AND LIGHT-SOURCE COVERING MADE THEREFROM

(71) Applicant: Basell Poliolefine Italia S.R.L., Milano (IT)

(72) Inventors: Yannic Kessler, Kriftel (DE); Erik Hans Licht, Mainz (DE); Carl Gunther Schirmeister, Denzlingen (DE); Rainer Köhler, Pegnitz (DE); Jürgen Rohrmann, Kelkheim (DE); Alberto Foguet Roca, Reus (ES)

(73) Assignee: Basell Poliolefine Italia S.R.L., Milano (IT)

(21) Appl. No.: 18/568,231

(22) PCT Filed: Dec. 22, 2021
(86) PCT No.: PCT/EP2021/087180

§ 371 Date: Dec. 7, 2023

(30) Foreign Application Priority Data
Jun. 10, 2021 (EP) 21178751.0

(51) Int. Cl. C08L 23/16; B29C 45/00; B29K 23/00; B29K 25/00; C08K 7/14; C08L 23/12; C08L 23/14; C08L 23/26; C08L 53/02

(52) U.S. Cl. CPC C08L 23/16; B29C 45/0001; C08K 7/14; C08L 23/12; C08L 23/14; C08L 23/26; C08L 53/02; B29K 2023/12; B29K 2023/14; B29K 2023/16; B29K 2025/08; C08K 2201/003; C08K 2201/004; C08L 2203/20; C08L 2203/30; C08L 2205/02; C08L 2205/035

(57) ABSTRACT

A covering for a light-source made from or containing a polyolefin composition made from or containing:
(A) 50-80% by weight of a propylene polymer made from or containing from 0.1 to 40% by weight of units deriving from ethylene or an alpha-olefin of formula CH₂═CHR¹, where R¹ is a linear or branched C²-C⁸ alkyl, based on the weight of (A);
(B) 15-35% by weight of an elastomeric component selected from the group consisting of:
   (B1) ethylene copolymers with an alpha-olefin,
   (B2) saturated or unsaturated styrene or alpha-methylstyrene block copolymers, and
   (B3) combinations thereof;
(C) 5-30% by weight of glass fibers; and
(D) 0-5.0% by weight of a compatibilizer,
wherein the amounts of (A), (B), (C), and (D) are based on the total weight of (A)+(B)+(C)+(D).

### FIELD OF THE INVENTION

In general, the present disclosure relates to the field of chemistry. More specifically, the present disclosure relates to polymer chemistry. In particular, the present disclosure relates to a propylene polymer composition and a light-source cover made therefrom.

### BACKGROUND OF THE INVENTION

In some instances, glass-filled polyolefins are used in the automotive field for the injection molding of interior and exterior parts. In some instances, glass-filled polyolefins have high strength and stiffness.

In some instances, soft-touch materials are used for car interiors, thereby increasing the tactile appeal of surfaces and creating the feeling of a living room inside the car.

In some instances, optical properties of plastics are relevant in the automotive field, for example with light bars or light spots covered with plastic material.

### SUMMARY OF THE INVENTION

In a general embodiment, the present disclosure provides a covering for a light-source made from or containing a polyolefin composition made from or containing:
(A) 50-80% by weight of a propylene polymer made from or containing up to and including 40% by weight of units deriving from ethylene or an alpha-olefin of formula CH₂═CHR¹, where R¹ is a linear or branched C²-C⁸ alkyl, based on the weight of (A);
(B) 15-35% by weight of an elastomeric component selected from the group consisting of:
   (B1) ethylene copolymers with an alpha-olefin of formula CH₂═CHR², where R² is a linear or branched C¹-C⁸ alkyl;
   (B2) saturated or unsaturated styrene or alpha-methylstyrene block copolymers, and
   (B3) combinations thereof:
(C) 5-30% by weight of glass fibers; and
(D) 0-5.0% by weight of a compatibilizer,
wherein the amounts of (A), (B), (C) and (D) are based on the total weight of (A)+(B)+(C)+(D), the total weight being 100%.

In some embodiments, the present disclosure provides a process for manufacturing a covering for a light-source including the step of shaping the covering from the polyolefin composition.

In some embodiments, the polyolefin composition is translucent and has low absorbance in the visible region of the light spectrum. In some embodiments, the polyolefin composition is used in manufacturing articles. In some embodiments, the articles are backlighted, that is, the light passing through the article without seeing the light source behind. In some embodiments, the article is a covering for a light-source.

In some embodiments, the absorbance does not change throughout the visible light spectrum, thereby allowing light of different colors to be transmitted through the article with the same intensity.

In some embodiments, the polyolefin composition has a balance of mechanical properties, alternatively flexural modulus and impact, in combination with low shrinkage. In some embodiments, the light-source coverings have aesthetic and structural function.

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DESCRIPTION OF THE DRAWING

FIG. 1 provides a plot of the absorbance values measured on 100 μm-thick films.

### DETAILED DESCRIPTION OF THE INVENTION

In the present disclosure, the percentages are expressed by weight, unless otherwise specified.

In the present disclosure, when the term “comprising” is referred to a polymer or to a polymer composition, mixture, or blend, the term should be construed to mean “comprising or consisting essentially of”.

In the present disclosure, the term “consisting essentially of” means that, in addition to the specified components, the polymer, the polyolefin composition, the polyolefin mixture, or the polyolefin blend may be further made from or containing other components, provided that the characteristics of the polymer or of the composition, mixture, or blend are not materially affected by the presence of the other components. In some embodiments, the other components are catalyst residues, antistatic agents, melt stabilizers, light stabilizers, antioxidants, and antiacids.

In some embodiments, the polyolefin composition is made from or containing:
50-80% by weight, alternatively 55-75% by weight, alternatively 60-70% by weight, of the propylene polymer (A):
15-35% by weight, alternatively 15-30% by weight, alternatively 20-23% by weight, of the elastomeric component (B):
5-30% by weight, alternatively 5-25% by weight, alternatively 7-20% by weight, of the glass fibers (C); and
0.15-5.0% by weight, alternatively 0.20-3.0% by weight, of the compatibilizer,
wherein the amounts of (A), (B) (C), and (D) are based on the total weight of (A)+(B)+(C)+(D), the total weight being 100%.

In some embodiments, components (A), (B), (C), and optionally (D) are selected from the components described below. In some embodiments, the polyolefin composition is made from or containing a combination of components (A), (B), (C), and optionally (D).

In some embodiments, the propylene polymer (A) is selected from the group consisting of a propylene random copolymer, a polyolefin composition made from or containing a propylene random copolymer, and a polyolefin composition made from or containing an heterophasic propylene polymer made from or containing a crystalline or semi-crystalline matrix phase and a rubbery phase dispersed therein.

In some embodiments, R¹ is an alkyl selected from the group consisting of butene-1, hexene-1, 4-methyl-1-pentene, octene-1, and combinations thereof, alternatively butene-1.

In some embodiments, propylene polymer (A) is selected from the group consisting of:
(A1) propylene copolymers with ethylene or an alpha-olefin of formula CH₂═CHR¹, where R¹ is a linear or branched C²-C⁸ alkyl, made from or containing up to and including 8.5% by weight, alternatively from 0.1 to 8.5% by weight, of units deriving from ethylene or the alpha-olefin, based on the weight of (A1):
(A2) polypropylene compositions made from or containing:
   (A2.1) 25-65% by weight of a propylene homopolymer or a propylene copolymer with ethylene or an alpha-olefin of formula CH₂═CHR¹, where R¹ is a linear or branched C²-C⁸ alkyl,
   wherein the copolymer made from or containing up to and including 2% by weight, alternatively from 0.1 to 2% by weight, of units deriving from ethylene or the alpha-olefin, based on the weight of (A2.1); and
   (A2.2) 35-75% by weight of a propylene copolymer with ethylene or an alpha-olefin of formula CH₂═CHR¹, where R¹ is a linear or branched C²-C⁸ alkyl, made from or containing up to and including 15% by weight, alternatively from 0.1 to 15% by weight, of units deriving from ethylene or the alpha-olefin, based on the weight of (A2.2), wherein the amounts of (A2.1) and (A2.2) are based on the total weight of (A2.1)+(A2.2), the total weight being 100%:
(A3) polypropylene compositions made from or containing:
   (A3.1) 55-80% by weight of a propylene polymer selected from the group consisting of propylene homopolymers, propylene copolymers with ethylene or an alpha-olefin of formula CH₂═CHR¹, where R¹ is a linear or branched C²-C⁸ alkyl, and mixtures thereof, wherein the copolymer made from or containing up to and including 10% by weight, alternatively from 0.1 to 10% by weight, of units deriving from ethylene or the alpha-olefin, based on the weight of (A3.1);
   (A3.2) 20-45% by weight of a copolymer of propylene with ethylene or an alpha-olefin of formula CH₂═CHR¹, where R¹ is a linear or branched C²-C⁸ alkyl, and mixtures thereof, made from or containing up to and including 40% by weight, alternatively from 15 to 40% by weight, of units deriving from ethylene or the alpha-olefin, based on the weight of (A3.2),
   wherein
      the polypropylene composition (A3) is made from or containing up to and including 40% by weight, alternatively from 0.1 to 40% by weight, of units deriving from ethylene or the alpha-olefin, based on the weight of (A3), and
      the amounts of (A3.1) and (A3.2) are based on the total weight of (A3.1)+(A3.2), the total weight being 100%:
(A4) polypropylene compositions made from or containing:
   (A4.1) 55-80% by weight of a propylene polymer selected from the group consisting of propylene homopolymers, propylene copolymers with ethylene or an alpha-olefin of formula CH₂═CHR¹, where R¹ is a linear or branched C²-C⁸ alkyl, and mixtures thereof, wherein the copolymer made from or containing up to and including 10% by weight, alternatively from 0.1 to 10% by weight, of units deriving from ethylene or the alpha-olefin, based on the weight of (A4.1);
   (A4.2) 20-45% by weight of a copolymer of ethylene with an alpha-olefin of formula CH₂═CHR¹, where R¹ is a linear or branched C²-C⁸ alkyl, and mixtures thereof, made from or containing up to and including 40% by weight, alternatively from 10 to 40% by weight, of units deriving from the alpha-olefin, based on the weight of (A4.2),
   wherein
      the polypropylene composition (A4) is made from or containing a total amount of up to and including 40% by weight, alternatively from 0.1 to 40% by weight, of units deriving from ethylene and the alpha-olefin, based on the weight of (A4), and the amounts of (A4.1) and (A4.2) are based on the total weight of (A4.1)+(A4.2), the total weight being 100%; and
(A5) mixtures thereof.

In some embodiments, propylene copolymer (A1) is selected from propylene-ethylene-butene-1 terpolymers (A1a) having from 0.5 to 1.8% by weight, alternatively from 0.7 to 1.5% by weight, alternatively from 0.9 to 1.3% by weight, of units deriving from ethylene, based on the weight of component (A1a), and from 3.5 to 6.5% by weight, alternatively from 4.5 to 6.0% by weight, alternatively from 4.8 to 5.8% by weight, of units deriving from butene-1, based on the weight of the (A1a).

In some embodiments, the propylene terpolymer (A1a) has a property selected from the following properties:
a total amount of units deriving from ethylene and butene-1 ranging from 5.5 to 7.5% by weight, alternatively from 5.7 to 7.1% by weight, based on the weight of (A1a); or
a melt flow rate, measured according to ISO 1133 (230° C., 2.16 Kg), ranging from 20 to 80 g/10 min., alternatively from 25 to 70 g/10 min., alternatively from 30 to 50 g/10 min.; or
a xylene soluble fraction lower than 7.0% by weight, alternatively lower than 5.5% by weight, based on the weight of (A1a); or
a melting point equal to or higher than 140° C., alternatively from 140° C. to 152° C.

In some embodiments, the propylene terpolymer (A1a) has the properties listed above.

In some embodiments, the polymeric chain of the propylene terpolymer (A1a) consists of units deriving from propylene, ethylene, and butene-1, wherein the propylene terpolymer has the properties listed above.

In some embodiments, the propylene polymers (A1), including the propylene terpolymers (A1a), are commercially available. In some embodiments, the propylene polymers (A1), including the propylene terpolymers (A1a), are obtained by polymerizing the relevant monomers, in the presence a highly stereospecific Ziegler-Natta catalyst systems made from or containing:
(1) a solid catalyst component made from or containing a magnesium halide support on which a Ti compound having a Ti-halogen bond is present, and a stereoregulating internal donor:
(2) optionally, an A1-containing cocatalyst; and
(3) optionally, a further electron-donor compound (external donor).

In some embodiments, the solid catalyst component (1) is made from or containing TiCl₄ in an amount securing the presence of from 0.5 to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes and combinations thereof.

In some embodiments, the donors are the esters of phthalic acids. In some embodiments, the esters of phthalic acids are as described in European Patent Application Nos. EP45977A2 and EP395083A2. In some embodiments, the esters of phthalic acids are selected from the group consisting of di-isobutyl phthalate, di-n-butyl phthalate, di-n-octyl phthalate, diphenyl phthalate, benzylbutyl phthalate, and combinations thereof.

In some embodiments, the esters of aliphatic acids are selected from the group consisting of esters of malonic acids, esters of glutaric acids, and esters of succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the stereoregulating internal electron donor compound are diesters derived from esterification of aliphatic or aromatic diols. In some embodiments, the diesters are as described in Patent Cooperation Treaty Publication No. WO2010/078494 and U.S. Pat. No. 7,388,061.

In some embodiments, the internal donor is selected from 1,3-diethers. In some embodiments, the 1,3-diethers are as described in European Patent No. EP361493, European Patent No. EP728769, and Patent Cooperation Treaty Publication No. WO02/100904.

In some embodiments, the internal donor is a mixture of aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal donor that remains fixed on the solid catalyst component (1) is 5 to 20% by moles, with respect to the magnesium dihalide.

In some embodiments, the solid catalyst component (1) is prepared as described in European Patent Application No. EP395083A2.

In some embodiments, the catalyst components are prepared as described in U.S. Pat. Nos. 4,399,054, 4,469,648, Patent Cooperation Treaty Publication No. WO98/44009A1, or European Patent Application No. EP395083A2.

In some embodiments, the catalyst system is made from or containing an A1-containing cocatalyst (2) selected from A1-trialkyls. In some embodiments, the A1-containing cocatalyst (2) is selected from the group consisting of A1-triethyl, A1-triisobutyl and A1-tri-n-butyl. In some embodiments, the A1/Ti weight ratio in the catalyst system is from 1 to 1000, alternatively from 20 to 800.

In some embodiments, the catalyst system is further made from or containing electron donor compound (3) (external electron donor). In some embodiments, the external electron donor is selected from the group consisting of silicon compounds, ethers, esters, amines, heterocyclic compounds, and ketones. In some embodiments, the heterocyclic compound is 2,2,6,6-tetramethylpiperidine.

In some embodiments, the silicon compounds are selected from the group consisting of methylcyclohexyldimethoxysilane (C-donor), dicyclopentyldimethoxysilane (D-donor), and mixtures thereof.

In some embodiments, the propylene copolymer (A1) is produced with a polymerization process and reactor as described in European Patent No. EP1012195B1. In some embodiments, the polymerization process is carried out in a gas-phase reactor, referred to herein as a “multizone circulating reactor (MZCR).” having two interconnected polymerization zones. The polymer particles flow upwards through a first polymerization zone, which is denominated “riser”, under fast fluidization or transport conditions, leave the riser, enter a second polymerization zone, which is denominated “downcomer”, through which the polymer particles flow in a densified form under the action of gravity. A continuous circulation of polymer is established between the riser and the downcomer. In some embodiments, a condition of fast fluidization is established in the riser by feeding a gas mixture made from or containing the monomers to the riser. In some embodiments, the catalyst system is fed to the reactor at a point of the riser.

In some embodiments, two polymerization zones with different composition are obtained by feeding a gas/liquid stream (barrier stream) to the upper part of the downcomer. In some embodiments, the gas/liquid stream acts as a barrier to the gas phase coming from the riser and establishes a net gas flow upward in the upper portion of the downcomer. In some embodiments, the established flow of gas upward prevents the gas mixture in the riser from entering the downcomer.

In some embodiments, the molecular weight of the propylene copolymers is regulated using chain transfer agents. In some embodiments, the chain transfer agent is hydrogen or ZnEt₂.

In some embodiments, the multizone circulating reactor is operated at a temperature of 50-120° C., alternatively of 70°-90° C., and at pressures of 0.5-10 MPa, alternatively of 1.5-6 MPa.

In some embodiments, the polypropylene composition (A2) is a blend of propylene polymers (A2.1) and (A2.2). In some embodiments, the blend is prepared in an extruder or a reactor. In some embodiments, the propylene polymer (A2.1) is a propylene homopolymer, and the propylene polymer (A2.2) is a random propylene-ethylene copolymer.

In some embodiments, the polypropylene composition (A2) has a property selected from the following properties:
made from or containing a total amount of units deriving from ethylene or the alpha-olefin, alternatively exclusively from ethylene, between 1 and 10% by weight, alternatively between 2 and 5% by weight, based on the weight of (A2); or
has a xylene soluble fraction lower than 10% by weight, alternatively lower than 7% by weight, based on the weight of (A2).

In some embodiments, the polyolefin composition has the properties listed above.

In some embodiments, the polypropylene compositions (A2) are commercially available. In some embodiments, the polypropylene compositions (A2) are obtained by melt blending component (A2.1) and component (A2.2). In some embodiments, the polypropylene compositions (A2) are obtained by polymerizing the relevant monomers in at least two polymerization stages, wherein the second and each subsequent polymerization stage is carried out in the presence of the polymer produced and the catalyst, which was used in the immediately preceding polymerization stage.

In some embodiments, the monomers are polymerized in the presence of a catalyst selected from the group consisting of metallocene compounds, highly stereospecific Ziegler-Natta catalyst systems, and combinations thereof. In some embodiments, the monomers are polymerized in the presence of a highly stereospecific Ziegler-Natta catalyst system.

In some embodiments, the polymerization to obtain single component (A2.1), the polymerization to obtain single component (A2.2), or the sequential polymerization process to obtain the polypropylene composition (A2) is carried out in a continuous or batch process. In some embodiments, the polymerization to obtain single component (A2.1), the polymerization to obtain single component (A2.2), or the sequential polymerization process to obtain the polypropylene composition (A2) is carried out in liquid phase or in gas phase.

In some embodiments, the liquid-phase polymerization occurs in slurry, solution, or bulk (liquid monomer). In some embodiments, the liquid-phase polymerization is carried out in various types of reactors. In some embodiments, the reactors are continuous stirred tank reactors, loop reactors, or plug-flow reactors.

In some embodiments, the gas-phase polymerization is carried out in fluidized or stirred, fixed bed reactors. In some embodiments, the gas-phase polymerization is carried out in a multizone circulating reactor as described in European Patent No. EP1012195.

In some embodiments, the reaction temperature is in the range from 40° C. to 90° C. In some embodiments, the polymerization pressure is from 3.3 to 4.3 MPa, for a process in liquid phase, and from 0.5 to 3.0 MPa, for a process in the gas phase.

In some embodiments, the polypropylene composition (A3) is a blend of a crystalline or semi-crystalline propylene polymer matrix (A3.1) and a rubbery propylene copolymer (A3.2). In some embodiments, the blend is prepared in an extruder or a reactor.

In some embodiments, the polypropylene composition (A4) is a blend of a crystalline or semi-crystalline propylene polymer matrix (A4.1) and a rubbery ethylene/alpha-olefin copolymer (A4.2). In some embodiments, the blend is prepared in an extruder or a reactor.

In some embodiments, the polypropylene composition (A4) is a polyolefin composition (A4a) made from or containing:
(A4.1a) 55-80% by weight of a propylene polymer selected from the group consisting of propylene homopolymers, propylene copolymers with ethylene or an alpha-olefin of formula CH₂═CHR¹, where R¹ is a linear or branched C²-C⁸ alkyl, and mixtures thereof, wherein the copolymers are made from or containing up to and including 10% by weight, alternatively from 0.1 to 10% by weight, of units deriving from ethylene or the alpha-olefin, based on the weight of (A4.1a), and wherein the propylene polymer (A4.1a) has a melt flow rate measured according to ISO 1133 (230° C., 2.16 kg) equal to or higher than 15 g/10 min., alternatively from 15 g/10 min. to 80 g/10. min., alternatively from 20 g/10 min. to 60 g/10 min.; and (A4.2a) 20-45% by weight of a copolymer of ethylene with an alpha-olefin of formula CH₂═CHR¹, where R¹ is a linear or branched C²-C⁸ alkyl, alternatively butene-1, made from or containing up to and including 40% by weight, alternatively from 10 to 40% by weight, of units deriving from the alpha-olefin, based on the weight of (A4.2a):

wherein
the polypropylene composition (A4a) is made from or containing a total amount of up to and including 40% by weight, alternatively from 0.1 to 40% by weight, of units deriving from ethylene and the alpha-olefin, based on the weight of (A4a), and the amounts of (A4.1a) and (A4.2a) are based on the total weight of (A4.1a)+(A4.2a), the total weight being 100%.

In some embodiments, the polyolefin composition (A4a) is made from or containing 60-80% by weight, alternatively 60-75% by weight, of the propylene polymer (A4.1a) and 20-40% by weight, alternatively 25-40% by weight, of the copolymer of ethylene (A4.2a), wherein the amounts of (A4.1a) and (A4.2a) are based on the total weight of (A4.1a)+(A4.2a), the total weight being 100%.

In some embodiments, the polyolefin composition (A4a) has a property selected from the following properties:
a xylene soluble fraction from 15% to 35% by weight, alternatively from 18% to 35% by weight, alternatively from 18% to 30% by weight, based on the weight of (A4a); or
an intrinsic viscosity of the xylene soluble fraction equal to or lower than 1.7 dl/g. alternatively from 0.8 to 1.7 dl/g, alternatively from 1.0 to 1.6 dl/g.

In some embodiments, the polyolefin composition (A4a) has the properties listed above.

In some embodiments, the polypropylene composition (A4a) is made from or containing:
(A4.1a) 55-80% by weight, alternatively 60-80% by weight, alternatively 60-75% by weight, of a propylene-ethylene copolymer made from or containing up to and including 7% by weight, alternatively from 0.1 to 7% by weight, alternatively from 0.1 to 5% by weight, of units deriving from ethylene, based on the weight of (A4.1a); and
(A4.2a) 20-45% by weight, alternatively 20-40% by weight, alternatively 25-40% by weight, of an ethylene-butene-1 copolymer made from or containing 10-40% by weight, alternatively 20-30% by weight, of units deriving from butene-1, based on the weight of (A4.2a),
   wherein the polypropylene composition (A4a) has:
a total amount of up to and including 40% by weight, alternatively from 0.1 to 40% by weight, of units deriving from ethylene and butene-1, based on the weight of (A4a):
a xylene soluble fraction from 15% to 35% by weight, alternatively from 18% to 35% by weight, alternatively from 18% to 30% by weight, based on the weight of (A4a); and
an intrinsic viscosity of the xylene soluble fraction equal to or lower than 1.7 dl/g, alternatively from 0.8 to 1.7 dl/g, alternatively from 1.0 to 1.6 dl/g, and
the amounts of (A4.1a) and (A4.2a) being based on the total weight of (A4.1a)+(A4.2a), the total weight being 100%.

In some embodiments, the propylene polymer compositions (A3) and (A4), including (A4a), are commercially available. In some embodiments, the propylene polymer compositions (A3) and (A4), including (A4a), are obtained by melt blending the matrix and the rubbery components. In some embodiments, the propylene polymer compositions (A3) and (A4), including (A4a), are by polymerizing the relevant monomers in at least two stages, wherein the second and each subsequent polymerization stage is carried out in the presence of the polymer produced and the catalyst, which was used in the immediately preceding polymerization stage. In some embodiments, the component (A3.1) or (A4.1), including (A4.1a), is produced in the first polymerization stage.

In some embodiments, the monomers are polymerized in the presence of a catalyst selected from the group consisting of metallocene compounds, highly stereospecific Ziegler-Natta catalyst systems, and combinations thereof. In some embodiments, the monomers are polymerized in the presence of a highly stereospecific Ziegler-Natta catalyst system.

In some embodiments, the polymerization process to obtain the polypropylene composition (A3) and (A4), including (A4a), is carried out continuously or in batch. In some embodiments, the polymerization process is carried out in liquid phase or in gas phase.

In some embodiments, the liquid-phase polymerization occurs in slurry, solution, or bulk (liquid monomer). In some embodiments, the liquid-phase polymerization is carried out in various types of reactors. In some embodiments, the reactors are continuous stirred tank reactors, loop reactors, or plug-flow reactors.

In some embodiments, the gas-phase polymerization is carried out in fluidized or stirred, fixed bed reactors.

In some embodiments, the reaction temperature is in the range from 40° C. to 90° C. In some embodiments, the polymerization pressure is from 3.3 to 4.3 MPa, for a process in liquid phase, and from 0).5 to 3.0 MPa, for a process in the gas phase.

In some embodiments, the molecular weight of the propylene copolymers is regulated using chain transfer agents. In some embodiments, the chain transfer agent is hydrogen or ZnEt₂.

In some embodiments, the propylene polymer (A) has a property selected from the following properties:
a melt flow rate (MFR(A)), measured according to ISO 1133 (230° C., 2.16 Kg), ranging from 5 to 80 g/10 min., alternatively from 10 to 60 g/10 min., alternatively from 10 to 50 g/10 min.; or
a tensile modulus, measured according to ISO 527-1,-2, equal to or greater than 900 MPa, alternatively ranging from 900 MPa to 2000 MPa, alternatively from 900 MPa to 1500 MPa. alternatively from 1000 MPa to 1400 MPa; or
a tensile stress at yield, measured according to ISO 527-1,-2, equal to or greater than 15 MPa, alternatively ranging from 15 MPa to 50 MPa, alternatively from 20 to 40 MPa; or
a tensile strain at yield, measured according to ISO 527-1,-2, ranging from 5% to 35%, alternatively from 10% to 30%.

In some embodiments, the propylene polymer (A) has the properties listed above.

In some embodiments, the elastomeric component (B) is an ethylene copolymer (B1) selected from ethylene copolymers with an alpha-olefin of formula CH₂═CHR², wherein R² is a linear or branched C¹-C⁸ alkyl. In some embodiments, the alpha-olefin is selected from the group consisting of butene-1, hexene-1, octene-1, and combinations thereof.

In some embodiments, the ethylene copolymer (B1) has at least 20% by weight, alternatively from 20% to 50% by weight, of units deriving from the alpha-olefin, based on the weight of (B1).

In some embodiments, the ethylene copolymers (B1) are commercially available under the tradename of Engage from The Dow Chemical Company. In some embodiments, the ethylene copolymers (B1) have the tradename Engage™ 8100 or Engage™ 8150. In some embodiments, ethylene copolymers (B1) are prepared using solution polymerization processes carried out in the presence of a metallocene-based catalyst system.

In some embodiments, the elastomeric component (B) is a saturated or unsaturated styrene or alpha-methylstyrene block copolymer (B2). In some embodiments, the elastomeric component (B) is a saturated or unsaturated styrene or alpha-methylstyrene block copolymer (B2) made from or containing up to and including 30% by weight, alternatively from 10% to 30% by weight, alternatively from 15% to 25% by weight, of polystyrene, based on the weight of (B2).

In some embodiments, the elastomeric component (B) is a styrene block copolymer (B2) selected from the group consisting of polystyrene-poly butadiene-polystyrene (SBS), polystyrene-poly(ethylene-butylene)-polystyrene (SEBS), polystyrene-poly(ethylene-propylene)-polystyrene (SEPS), polystyrene-polyisoprene-polystyrene (SIS), polystyrene-poly(isoprene-butadiene)-polystyrene (SIBS), and mixtures thereof. In some embodiments, the styrene block copolymer (B2) is a polystyrene-poly (ethylene-butylene)-polystyrene (SEBS).

In some embodiments, the styrene block copolymer (B2) has a property selected from the following properties:
MFR, measured according to ASTM D1238 (230° C. 2.16 Kg), ranging from 5 to 80 g/10 min . . . alternatively from 10 to 60 g/10 min . . . alternatively from 10 to 30 g/10 min; or
Shore A value, measured according to ASTM 2240) (30 sec.), equal to or lower than 70, alternatively ranging from 30 to 70, alternatively from 30 to 60.

In some embodiments, the styrene block copolymer has the properties listed above.

In some embodiments, styrene or alpha-methylstyrene block copolymers (B2) are prepared by ionic polymerization of the relevant monomers. In some embodiments, styrene or alpha-methylstyrene block copolymers (B2) are commercially available under the tradename of Kraton™ from Kraton Polymers.

In some embodiments, the glass fibers (C) have a diameter ranging from 5 to 20 μm, alternatively from 8 to 15 μm, and a length equal to or lower than 10 mm, alternatively ranging from 0).1 to 10 mm, alternatively from 1 to 8 mm, alternatively from 2 to 7 mm, alternatively from 3 to 6 mm.

In some embodiments, the compatibilizer (D) increases the compatibility of the glass fibers with the components (A) and (B). In some embodiments, the compatibilizer (D) is a modified olefin polymer, functionalized with polar compounds, and, optionally, with a low molecular weight compound, having a reactive polar group. In some embodiments, the modified olefin polymer is selected from the group consisting of polyethylenes, polypropylenes, and mixtures thereof.

In some embodiments, the modified olefin polymers are selected from the group consisting of graft copolymers, block copolymers, and mixtures thereof.

In some embodiments, the modified polymers are functionalized with groups derived from polar compounds. In some embodiments, the polar compounds are selected from the group consisting of acid anhydrides, carboxylic acids, carboxylic acid derivatives, primary and secondary amines, hydroxyl compounds, oxazoline, epoxides, ionic compounds, and combinations thereof. In some embodiments, the polar compounds are selected from the group consisting of unsaturated cyclic anhydrides, related aliphatic diesters, and diacid derivatives.

In some embodiments, the compatibilizer (D) is a polyolefin, functionalized with a compound selected from the group consisting of maleic anhydride. C¹-C¹⁰ linear or branched dialkyl maleates. C¹-C¹⁰ linear or branched dialkyl fumarates, itaconic anhydride. C¹-C¹⁰ linear or branched itaconic acid, dialkyl esters, maleic acid, fumaric acid, itaconic acid, and mixtures thereof. In some embodiments, the polyolefin is selected from the group consisting of polyethylenes, polypropylenes, and mixtures thereof.

In some embodiments, the compatibilizer (D) is a polyethylene or a polypropylene grafted with maleic anhydride (MAH-g-PP or MAH-g-PE).

In some embodiments, the compatibilizer (D) is a polyethylene or a polypropylene grafted with maleic anhydride, having a property selected from the following properties:
a maleic anhydride graft level equal to or greater than 0.5 wt. %, alternatively from 0).5 wt. % to 3.0 wt. %, alternatively from 0).75% to 2.0%, based on the component (B); or
a melt flow rate, determined according to the method ISO 1133 (190° C. 2.16 kg), ranging from equal to or greater than 80 g/10 min . . . alternatively ranging from 80 to 200 g/10 min.

In some embodiments, the polyethylene or polypropylene grafted with maleic anhydride has the properties listed above.

In some embodiments, the modified polymers are produced by functionalization processes carried out in solution, in the solid state, or in the molten state. In some embodiments, the modified polymers are produced by functionalization processes carried out in the molten state. In some embodiments, the modified polymers are produced by reactive extrusion of the polymer in the presence of the grafting compound and of a free radical initiator. In some embodiments, the functionalization of polypropylene or polyethylene with maleic anhydride is as described in European Patent Application No. EP0572028A1.

In some embodiments, the modified polyolefins are selected from products commercially available under the trademark Amplify™ TY from The Dow Chemical Company, the trademark Exxelor™ from ExxonMobil Chemical Company, the trademark SconaR TPPP from Byk (Altana Group), the trademark Bondyram® from Polyram Group, the trademark Polybond* from Chemtura. and combinations thereof.

In some embodiments, the polyolefin composition is further made from or containing up to and including 1.0% by weight, alternatively from 0.01 to 1.0% by weight, of a clarifying or a nucleating agent (E), wherein the amount of (E) is based on the total weight of (A)+(B)+(C)+(D)+(E), the total weight being 100%.

In some embodiments, the polyolefin composition is further made from or containing up to and including 3.0% by weight of an additive, based on the total weight of the polyolefin composition. In some embodiments, the additive is selected from the group consisting of antistatic agents, anti-oxidants, light stabilizers, slipping agents, anti-acids, melt stabilizers, and combinations thereof.

In some embodiments, the polyolefin composition has a property selected from the following properties:
flexural modulus, measured according to ISO 178/A:2019-04 on injection molded specimens obtained according to EN ISO 20753 (Type B2), equal to or greater than 800 MPa, alternatively equal to or greater than 1000 MPa, alternatively equal to or greater than 1100 MPa; or
Charpy impact strength, according to ISO 179/−1eA:2010-11 (notched, 23° C.) measured on injection molded specimens obtained according to EN ISO 20753 (Type B2), ranging from 10 to 45 KJ/m², alternatively from 15 to 35 kJ/m²; or
Charpy impact strength, according to ISO 179/−1eA:2010-11 (notched,-30° C.) measured on injection molded specimens obtained according to EN ISO 20753 (Type B2), ranging from 1 to 10 KJ/m², alternatively from 1.5 to 8 KJ/m²; or
shrinkage in longitudinal direction lower than 0.70%, alternatively lower than 0.50%; or
shrinkage in the transversal direction lower than 1.00%, alternatively lower than 0.85%; or
haze on 1 mm-thick plaques equal to or greater than 85%, alternatively equal to or greater than 95%; or
absorbance ABS1 at wavelengths ranging from 380 to 780 nm, measured on a 100 μm-thick film, lower than 0.70, alternatively lower than 0.60; or
absorbance ABS2(380) or ABS2(780), measured respectively at 380 nm and 780 nm on 1 mm-thick plaques, equal to or lower than 1.6; or
the variation of absorbance AABS2, measured on 1 mm-thick plaques, equal to or lower than 0.4, alternatively equal to or lower than 0.3, wherein the variation of the absorbance is determined by the following equation:

$${ΔABS}_{2} = \vert {ABS}_{2} ( 380 ) - {ABS}_{2} ( 780 ) \vert$$

wherein ABS2(380) is the absorbance measured at a wavelength of 380 nm and ABS2(780) is the absorbance measured at 780 nm.

In some embodiments, the polyolefin composition has the properties listed above.

In some embodiments, the polyolefin composition is obtained by melt blending the components (A), (B), (C), and, optionally. (D) and (E) in melt blending equipment. In some embodiments, the melt blending equipment is a twin-screw extruder, thereby forming a molten polyolefin composition, pushing the molten polyolefin composition through a die, and solidifying the molten polyolefin composition.

In some embodiments, the polyolefin composition is further made from or containing up to and including 10% by weight of an organic or inorganic pigment. In some embodiments, a polyolefin composition free of the pigment has the previously-described optical properties.

In some embodiments, the covering for a light-source is made from or containing the polyolefin composition.

In some embodiments, the polyolefin composition has a balance of optical and mechanical properties, thereby rendering the polyolefin composition useful as a covering for a light-source.

In some embodiments, the present disclosure provides a covering for a light-source made from or containing the polyolefin composition.

In some embodiments, the present disclosure provides method for covering a light-source including the steps of:
(a) shaping the polyolefin composition, thereby obtaining a covering; and
(b) positioning the covering before a light-source to shield the light. In some embodiments, the covering partially shields the light.

In some embodiments, the present disclosure provides a process for manufacturing a covering for a light-source made from or containing the polyolefin composition, including step (i) of shaping the polyolefin composition by injection molding, cast extrusion, profile extrusion, rotational molding, blow molding, or deep drawing.

In some embodiments, the covering for a light-source is a sheet having thickness of up to and including 30 mm, alternatively ranging from 1 to 10 mm.

The features describing the subject matter of the present disclosure are not inextricably linked to each other. In some embodiments, a level of a feature does not involve the same level of the remaining features of the same or different components. In some embodiments, a range of features of components from (A) to (E) is combined independently from the level of the other components, and that components from (A) to (E) are combined with an additional component and the component's features.

### EXAMPLES

The following examples are illustrative and not intended to limit the scope of the disclosure in any manner whatsoever.

### Characterization Methods

The following methods are used to determine the properties indicated in the description, claims and examples.

Melt Flow Rate: Determined according to the method ISO 1133 (230° C. 2.16 Kg for the thermoplastic polyolefins: 190° C./2.16 Kg for the compatibilizer).

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C. without stirring during the first 20 minutes, and maintained at 25° C. with stirring for the last 10 minutes. The formed solid was filtered on quick filtering paper (for example. Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(I) and XSA values were experimentally determined. The fraction of component (B) soluble in xylene at 25° C. (XSB) was calculated from the formula:

$$X S = W ( A ) \times ( X {S}_{A} ) + W ( B ) \times ( X {S}_{B} )$$

wherein W(A) and W(B) are the relative amounts of components (A) and (B), respectively, and W(A)+W(B)=1.

C² content in propylene-ethylene copolymer (II): 13C NMR spectra were acquired on a Bruker AV-600 spectrometer equipped with cryoprobe, operating at 160.91 MHz in the Fourier transform mode at 120° C. The peak of the PBB carbon (nomenclature according to C. J. Carman. R. A. Harrington and C. E. Wilkes. Macromolecules. 10, 3, 536 (1977)) was used as internal standard at 2.8 ppm. The samples were dissolved in 1.1.2.2-tetrachloroethane-d2 at 120° C. with an 8% wt/v concentration. Each spectrum was acquired with a 90° pulse. 15 seconds of delay between pulses and CPD, thereby removing 1H-13C coupling. 512 transients were stored in 32K data points using a spectral window of 9000 Hz. The assignments of the spectra, the evaluation of triad distribution and the composition were made according to Kakugo [M. Kakugo, Y. Naito, K. Mizunuma and T. Miyatake, Macromolecules, 16, 4, 1160 (1982)]. In view of the amount of propylene inserted as regioirregular units, ethylene content was calculated according to Kakugo [M. Kakugo, Y. Naito, K. Mizunuma and T. Miyatake, Macromolecules, 16, 4, 1160 (1982)] using triad sequences with P inserted as regular unit.

$$PPP = 100 {T}_{β β} / S$$

$$PPE = 100 {T}_{βδ} / S$$

$$EPE = 100 {T}_{δδ} / S$$

$$PEP = 100 {S}_{β β} / S$$

$$PEE = 100 {S}_{βδ} / S$$

$$EEE = 100 ( 0.25 {S}_{γδ} + 0.5 {S}_{δδ} ) / S$$

$$where S = {T}_{β β} + {T}_{βδ} + {T}_{δδ} + {S}_{β β} + {S}_{βδ} + 0.25 {S}_{γδ} + 0.5 {S}_{δδ}$$

Tensile Modulus, Stress and Strain at yield: Determined according to the method ISO 527-1, -2:2019 on specimens according to ISO 20753-A1:2018-10.

Flexural Modulus: determined according to ISO 178/A:2019-04 on injection molded specimens Type B2 according to ISO 20753.

Charpy impact strength: measured according to ISO 179 1eA, notched at 23° C. and −30° C. on injection molded specimens Type B2 according to ISO 20753.

Thermal shrinkage: a plaque of 195×100×2.5 mm was molded in an injection molding machine Krauss Maffei KM250/1000C² (250 tons of claiming force) under the following injection molding conditions:
melt temperature: 220° C.;
mold temperature: 35° C.;
injection time: 3.6 s;
holding time: 30 s; and
screw diameter: 55 mm

The plaque was annealed at 23° C. for 48 h. The length (L) and the width (W) of the plaque were measured. The thermal shrinkage was calculated according to the following formulas:

$$longitudinal shrinkage = [ ( 195 - L ) / 195 ] \times 100$$

$$transversal shrinkage = [ ( 100 - W ) / 100 ] \times 100$$

wherein
195 and L are respectively the dimension of the mold and the measured dimensions of the plaque along the flow direction, in mm; and 100 and W are respectively the dimension of the mold and the measured dimensions of the plaque crosswise the flow direction, in mm.
The values indicated in the tables are the arithmetic mean of measures taken on five plaques.

Haze: the method determined the percentage of transmitted light that deviated from the incident beam by forward scattering when passed through the specimen and was in accordance with ASTM D1003 (non-compensated method). As used herein, the term “haze” refers to light deviating more than 2.5°. The haze value was determined using a hazemeter such as BYK-Gardner Hazegard Plus, or an equivalent instrument with CIE illuminant C and an integrated sphere geometry in accordance with ASTM D1003. 1 mm-thick plaques were conditioned at 23±2° C. and 50+10% humidity for 24 h prior to testing. The plaques were placed in contact with the haze port. Measurements were made at the center of the test specimen. The test instrument calculated the haze value, based on the following formula:

$$Haze [ \% ] = {T}_{d} / {T}_{t} \times 100$$

wherein Td was the diffuse transmittance and Tt was the total transmittance.

Absorbance: the absorbance in the UV-VIS spectrum was measured directly on 100 μm-thick films and 1 mm-thick injection molded plaques with an Evolution™ 220) Spectrophotometer (by Thermo Fischer Scientific), under the following conditions:
scan: 380-800 nm
speed: 200) nm/min
slit: 2 nm
data interval: 1 nm.

Total light transmittance: the method determined the percentage of transmitted light when passed through the specimen. The transmittance value was determined using a hazemeter such as Hazegard Hazemeter XL-211, or an equivalent instrument and an integrated sphere geometry to collect scattered light. The collected light was measured with a photodetector, having the photodetector's spectral sensitivity modified by filters, thereby approximating the response of the 1931 CIE standard Observer for Source C. 3 mm-thick plaques were conditioned at 23±2° C. and 50+10% humidity for at least 48 h prior to testing. After the equipment was calibrated to adjust to 100% of transmission, the plaques were placed in contact with the haze/transmittance port and measurements were made at the center of the test specimen. The test instrument calculated the total light transmittance value.

Injection molded plaques for haze and absorbance determination: 1 mm-thick plaques were obtained using an injection molding machine Negri Bossi VE70 operated in the following conditions:
screw rotation speed: 125 rpm
back pressure: 100 bar
mold temperature: 40° C.
melt temperature: 230° C.
injection time: 1 sec
1^{st} hold pressure stage time: 20 sec
2^{nd} hold pressure stage time: 5 sec
cooling time: 10 sec
   The two-cavity mold was in accordance with ISO 294-3:2020 (D11).

Injection molded plaques for light transmission determination: 3 mm-thick plaques were obtained using an injection molding machine Krauss Maffei CX 160-750 (160 tons of claiming force) operated in the following conditions:

screw rotation speed: 100 rpm back pressure: 5 bar mold temperature: 35° C. melt temperature: 220° C. injection time: 4 sec hold pressure: 35 bar hold pressure stage time: 10 sec cooling time: 35 sec

Films preparation: 100 μm-thick films for optical measures were produced by compression molding, using a Constant Thickness Film-Maker supplied by Specac Ltd. (diameter 29 mm) and equipped with a ring/separator and a Carver press operated at 190° C. and 2 tons of pressure.

### Raw Materials:

PP1: a propylene-ethylene-butene-1 terpolymer, containing 1.1 wt. % ethylene units and 5.3 wt. % of butene-1 units and having a xylene soluble fraction of 5.0 wt. %, was prepared according to the polymerization process described in Example 1 of Patent Cooperation Treaty Publication No. WO2014/198459. The polymer particles were mixed in the molten state with 0.4 wt. % of Millad® NXR 8000, 0.05 wt. % of calcium stearate, 0.1 wt. % of glyceryl monostearate (GMS 90), 0.1 wt. % of IrgafosR 168, and 0.05 wt. % of an antioxidant. The extruder was operated under nitrogen atmosphere at a rotational speed of 250 rpm and a temperature of 200-250° C. The properties of the resulting material are reported in Table 1.

PP2: polypropylene composition was made from or containing a propylene-ethylene random copolymer, containing 3.0 wt. % of ethylene units. The polypropylene composition had a xylene soluble fraction of 6 wt. %. The polypropylene composition was produced in two loop reactors, according to the polymerization process described in Example 1 of Patent Cooperation Treaty Publication No. WO2006/018813. The resulting polymer particles were mixed in the molten state with 0.18 wt. % of DMDBS, 0.05 wt. % of calcium stearate, 0.05 wt. % of glyceryl monostearate (GMS 90), 0.1 wt. % of IrgafosR 168, and 0.05 wt. % of an antioxidant. The extruder was operated under nitrogen atmosphere at a rotational speed of 250 rpm and a temperature of 200-250° C. The properties of the resulting material are reported in Table 1.

PP3: polypropylene composition was made from or containing 31 wt. % of a propylene-ethylene copolymer, having MFR (ISO 1133: 230° C., 2.16 Kg) of 39 g/10 min., and 69 wt. % of an ethylene-butenel copolymer. The polypropylene composition had a xylene soluble fraction of 20 wt. % and an intrinsic viscosity of the xylene soluble fraction of 1.45 dl/g. The composition had 24 wt. % of units deriving from ethylene and 7.2 wt. % of units deriving from butene-1. The polypropylene composition was obtained according to the polymerization process described in Examples 1-3 of Patent Cooperation Treaty Publication No. WO2004/003073. The polymer particles were mixed in the molten state with 0.18 wt. % of DMDBS, 0.05 wt. % of calcium stearate, 0.05 wt. % of glyceryl monostearate (GMS 90), 0.1 wt. % of Irgafos® 168, and 0.05 wt. % of an antioxidant. The extruder was operated under nitrogen atmosphere at a rotational speed of 250 rpm and a temperature of 200-250° C. The properties of the resulting material are reported in Table 1.

TABLE 1

| | | PP1 | PP2 | PP3 |
|---|---|---|---|---|
| MFR (230° C./2.16 Kg) | g/10 min. | 40 | 11 | 20 |
| Tensile Modulus | MPa | 1250 | 1150 | 1150 |
| Tensile Stress at yield | MPa | 30 | 30 | 23 |
| Tensile Strain at yield | % | 11 | 14 | 13 |

Moplen HF50 IN, a propylene homopolymer commercially available from LyondellBasell, had a melt flow rate of 12 g/10 min. (ISO1133: 230° C./2.16 Kg) and a tensile modulus (ISO 527-1, -2:2019) of 1550 MPa.

Kraton™ G1643 V, a linear styrene triblock copolymer commercially available from Kraton Corp., based on styrene and ethylene/butylene, containing 20 wt. % of polystyrene, having a MFR (ASTM D1238: 230° C., 2.16 Kg) of 19 g/10 min., and having a Shore A value (ASTM D2240, 30 sec.) of 52.

Kraton G1657 V, a linear triblock copolymer commercially available from Kraton Corp., based on styrene and ethylene/butylene with a polystyrene content of 13 wt. %, having a MFR (ASTM D1238: 230° C. and 5 Kg) of 22 g/10 min., and a Shore A value (ASTM D2240, 10 sec.) of 47.

GF EC10 636: ThermoFlow& 636 commercially available from Johns Manville, chopped E-glass fibers having fiber diameter of 10 μm and chopped strands length of 4 mm.

Bondyram® 1101, maleic anhydride modified polypropylene compound with a maleic anhydride content (FTIR) of 1 wt. % and a melt flow index (ISO 1133, 190° C./2.16 Kg) of 170 g/10 min., commercially available from Polyram Plastic Industries LTD.

DMDBS, Millad 3988 1,3:2,4-bis(3,4-dimethyldibenzylidene) sorbitol, commercially available from Milliken Chemical.

Millad& NX& 8000, a clarifying agent, commercially available from Milliken Chemical.

Irgafos® 168, a processing stabilizer, commercially available from BASF.

### Comparative Examples CE1-CE2 and Examples E3-E5

PPI was melt blended with the components reported in Table 2 in a twin screw extruder Doppelschneckenextruder 40 mm from Werner & Pfleiderer (Stuttgart, Germany) having screw length to diameter ratio of 48, operated under nitrogen atmosphere in the following conditions:
screw rotation speed: 300 rpm;
melt temperature: from 190° to 200° C.

The polypropylene compositions were tested for mechanical and optical properties and the results are illustrated in Table 2.

TABLE 2

| | | CE1 | CE2 | E3 | E4 | E5 |
|---|---|---|---|---|---|---|
| Kraton | wt. % | 25 | 18 | 25 | 25 | 20 |
| G1643S | | | | | | |
| PP1 | wt. % | 71 | 76 | 66 | 61 | 61 |
| GF EC10 636 | wt. % | / | 2 | 5 | 10 | 15 |
| Bondyram | wt. % | / | 0.2 | 0.25 | 0.5 | 0.8 |
| 1101 | | | | | | |
| MP HF501N | wt. % | 3.6 | 3.4 | 3.35 | 3.1 | 2.8 |
| Antioxidants | wt. % | 0.2 | 0.2 | 0.2 | 0.2 | 0.2 |
| UV stabilizer | wt. % | 0.1 | 0.1 | 0.1 | 0.1 | 0.1 |
| Mg oxide | wt. % | 0.1 | 0.1 | 0.1 | 0.1 | 0.1 |
| MFR | g/10 min | 35 | 29 | 23 | 19 | 16 |
| (230° C./2.16 Kg) | | | | | | |
| Flex. mod. | MPa | 733 | 1050 | 1108 | 1561 | 2346 |
| Charpy impact, | kJ/m² | 36 | 11 | 18 | 18 | 17 |
| notched 23° C. | | | | | | |
| Charpy impact, | kJ/m² | 1.8 | 1.7 | 2.2 | 3.7 | 5.5 |
| notched −30° C. | | | | | | |
| Shrinkage | % | 0.69 | 0.67 | 0.33 | 0.18 | 0.15 |
| (long.) | | | | | | |
| Shrinkage | % | 0.91 | 0.97 | 0.65 | 0.57 | 0.61 |
| (transv) | | | | | | |
| Vicat A | ° C. | 107 | 119 | 119 | 124 | 132 |
| Vicat B | ° C. | 48 | 58 | 52 | 56 | 65 |
| Haze | % | 31.3 | / | / | 95.7 | 99.4 |
| ABS₂(380) | | 0.36 | / | / | 1.08 | 1.38 |
| ABS₂(780) | | 0.16 | / | / | 0.92 | 1.08 |
| ΔABS₂ | | 0.20 | / | / | 0.16 | 0.30 |

### Comparative Examples CE6-CE7 and Examples E8-E10

PP2 was melt blended with the components reported in Table 3, with the same extruder and extruding conditions used in the preceding examples.

The polypropylene compositions were tested for mechanical and optical properties and the results are illustrated in Table 3.

TABLE 3

| | | CE6 | CE7 | E8 | E9 | E10 |
|---|---|---|---|---|---|---|
| Kraton | wt. % | 28 | 18 | 25 | 25 | 20 |
| G1643S | | | | | | |
| PP2 | wt. % | 71 | 76 | 66 | 61 | 61 |
| GF EC10 636 | wt. % | / | 2 | 5 | 10 | 15 |
| Bondyram | wt. % | / | 0.2 | 0.25 | 0.5 | 0.8 |
| 1101 | | | | | | |
| MP HF501N | wt. % | 3.6 | 3.4 | 3.35 | 3.1 | 2.8 |
| Antioxidants | wt. % | 0.2 | 0.2 | 0.2 | 0.2 | 0.2 |
| UV stabilizer | wt. % | 0.1 | 0.1 | 0.1 | 0.1 | 0.1 |
| Mg oxide | wt. % | 0.1 | 0.1 | 0.1 | 0.1 | 0.1 |
| MFR | g/10 min | 13 | 10 | 10 | 8 | 7 |
| (230° C./2.16 Kg) | | | | | | |
| Flex. mod. | MPa | 560 | 870 | 908 | 1310 | 2010 |
| Charpy impact, | kJ/m² | 60 | 18 | 23 | 23 | 20 |
| notched 23° C. | | | | | | |
| Charpy impact, | kJ/m² | 1.4 | 1.6 | 2.1 | 3.7 | 4.9 |
| notched −30° C. | | | | | | |
| Shrinkage | % | 0.75 | 0.76 | 0.39 | 0.22 | 0.16 |
| (long.) | | | | | | |
| Shrinkage | % | 1.2 | 1.24 | 0.81 | 0.68 | 0.72 |
| (transv) | | | | | | |
| Vicat A | ° C. | 113 | 127 | 125 | 132 | 138 |
| Vicat B | ° C. | 49 | 58 | 54 | 57 | 67 |
| Haze | % | 34.8 | / | / | 96.3 | 99.9 |
| ABS₂(380) | | 0.36 | / | / | 1.16 | 1.46 |
| ABS₂(780) | | 0.16 | / | / | 1.04 | 1.30 |
| ΔABS₂ | | 0.20 | / | / | 0.12 | 0.16 |

### Comparative Examples CE11-CE12 and Examples E13-E15

PP3 was melt blended with the components reported in Table 4, with the same extruder and extruding conditions used in the preceding examples.

The polypropylene compositions were tested for mechanical and optical properties and the results are illustrated in Table 4.

TABLE 4

| | | CE11 | CE12 | E13 | E14 | E15 |
|---|---|---|---|---|---|---|
| Kraton | wt. % | 25 | 18 | 25 | 25 | 20 |
| G1643S | | | | | | |
| PP3 | wt. % | 71 | 76 | 66 | 61 | 61 |
| GF EC10 636 | wt. % | / | 2 | 5 | 10 | 15 |
| Bondyram | wt. % | / | 0.2 | 0.25 | 0.5 | 0.8 |
| 1101 | | | | | | |
| MP HF501N | wt. % | 3.4 | 3.2 | 3.15 | 2.9 | 2.6 |
| DMDBS | wt. % | 0.2 | 0.2 | 0.2 | 0.2 | 0.2 |
| Antioxidants | wt. % | 0.2 | 0.2 | 0.2 | 0.2 | 0.2 |
| UV stabilizer | wt. % | 0.1 | 0.1 | 0.1 | 0.1 | 0.1 |
| Mg oxide | wt. % | 0.1 | 0.1 | 0.1 | 0.1 | 0.1 |
| MFR | g/10 min | 20 | 19 | 14 | 12 | 11 |
| (230° C./2.16 Kg) | | | | | | |
| Flex. mod. | MPa | 495 | 726 | 832 | 1172 | 1786 |
| Charpy impact, | kJ/m² | 68 | 35 | 36 | 38 | 34 |
| notched 23° C. | | | | | | |
| Charpy impact, | kJ/m² | 3.1 | 3.4 | 5.4 | 7.1 | 8.3 |
| notched −30° C. | | | | | | |
| Shrinkage | % | 0.56 | 0.65 | 0.29 | 0.18 | 0.14 |
| (long.) | | | | | | |
| Shrinkage | % | 1.01 | 1.15 | 0.68 | 0.62 | 0.64 |
| (transv) | | | | | | |
| Vicat A | ° C. | 95 | 110 | 107 | 114 | 126 |
| Vicat B | ° C. | 42 | 45 | 41 | 42 | 47 |
| Haze | % | 44.7 | 70.9 | 87.5 | 97.0 | 99.9 |
| ABS₂(380) | | / | / | / | 1.32 | 1.58 |
| ABS₂(780) | | / | / | / | 1.04 | 1.28 |
| ΔABS₂ | | / | / | / | 0.28 | 0.30 |

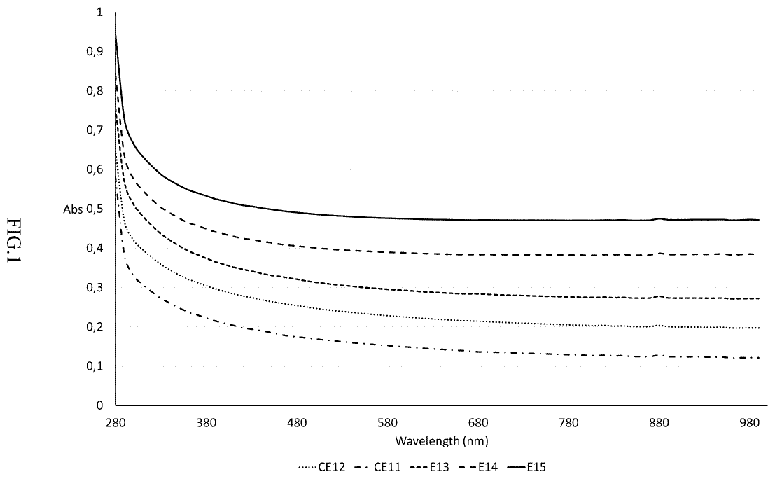

The absorbance ABS1 of 100 μm thick films at wavelength from 280 to 990 nm was measured for the compositions of comparative examples CE11-CE12 and for examples E13-E15. Plot of the absorbance as function of the wavelength is illustrated in FIG. 1.

### Example E16

Values of the mechanical properties and of the total light transmittance, measured on 3 mm-thick plaques, of a polyolefin composition are reported in Table 5.

TABLE 5

| | | E16 |
|---|---|---|
| PP1 | wt. % | 37 |
| PP2 | wt. % | 20 |
| Kraton G1643S | wt. % | 27 |
| Kraton G1657VS | wt. % | 5 |
| GF EC10 636 | wt. % | 7 |
| Additives + carrier | wt. % | 4 |
| MFR (230° C./2.16 Kg) | g/10 min | 15.5 |
| Flex. mod. | MPa | 1101 |
| Charpy impact, notched 23° C. | kJ/m² | 36 |
| Light transmission | % | 62 |

1. A covering for a light-source comprising:
a polyolefin composition comprising
(A) 50-80% by weight, of a propylene polymer comprising from 0.1 to 40% by weight of units deriving from ethylene or an alpha-olefin of formula CH₂═CHR¹, where R¹ is a linear or branched C²-C⁸ alkyl, based on the weight of (A);
(B) 15-35% by weight of an elastomeric component selected from the group consisting of:
(B1) ethylene copolymers with an alpha-olefin of formula CH₂═CHR², where R² is a linear or branched C¹-C⁸ alkyl,
(B2) saturated or unsaturated styrene or alpha-methylstyrene block copolymers, wherein the block copolymer comprises from 10% to 30% by weight of polystyrene, based on the weight of (B2); and
(B3) combinations thereof;
(C) 5-30% by weight of glass fibers; and
(D) 0-5.0% by weight of a compatibilizer,
wherein the amounts of (A), (B), (C), and (D) are based on the total weight of (A)+(B)+(C)+(D).

2. The covering for a light-source according to claim 1, wherein the propylene copolymer (A) is selected from the group consisting of:
(A1) propylene copolymers with ethylene or an alpha-olefin of formula CH₂═CHR¹, where R¹ is a linear or branched C²-C⁸ alkyl, comprising from 0.1 to 8.5% by weight of units deriving from ethylene or the alpha-olefin, based on the weight of (A1);
(A2) polypropylene compositions comprising:
(A2.1) 25-65% by weight of a propylene homopolymer or a propylene copolymer with ethylene or an alpha-olefin of formula CH₂═CHR¹, where R¹ is a linear or branched C²-C⁸ alkyl,
wherein the copolymer comprising from 0.1 to 2% by weight of units deriving from ethylene or the alpha-olefin, based on the weight of (A2.1); and
(A2.2) 35-75% by weight of a propylene copolymer with ethylene or an alpha-olefin of formula CH₂═CHR¹, where R¹ is a linear or branched C²-C⁸ alkyl, comprising from 0.1 to 15% by weight of units deriving from ethylene or the alpha-olefin, based on the weight of (A2.2),
wherein the amounts of (A2.1) and (A2.2) are based on the total weight of (A2.1)+(A2.2);
(A3) polypropylene compositions comprising:
(A3.1) 55-80% by weight of a propylene polymer selected from the group consisting of propylene homopolymers, propylene copolymers with ethylene or an alpha-olefin of formula CH₂═CHR¹, where R¹ is a linear or branched C²-C⁸ alkyl, and mixtures thereof,
wherein the copolymer comprising from 0.1 to 10% by weight of units deriving from ethylene or the alpha-olefin, based on the weight of (A3.1);
(A3.2) 20-45% by weight of a copolymer of propylene with ethylene or an alpha-olefin of formula CH₂═CHR¹, where R¹ is a linear or branched C²-C⁸ alkyl, and mixtures thereof, comprising from 15 to 40% by weight of units deriving from ethylene or the alpha-olefin, based on the weight of (A3.2),
wherein
the polypropylene composition (A3) comprises from 0.1 to 40% by weight of units deriving from ethylene or the alpha-olefin, based on the weight of (A3), and
the amounts of (A3.1) and (A3.2) are based on the total weight of (A3.1)+(A3.2);
(A4) polypropylene compositions comprising:
(A4.1) 55-80% by weight of a propylene polymer selected from the group consisting of propylene homopolymers, propylene copolymers with ethylene or an alpha-olefin of formula CH₂═CHR¹, where R¹ is a linear or branched C²-C⁸ alkyl, and mixtures thereof,
wherein the copolymer comprising from 0.1 to 10% by weight of units deriving from ethylene or the alpha-olefin, based on the weight of (A4.1);
(A4.2) 20-45% by weight of a copolymer of ethylene with an alpha-olefin of formula CH₂═CHR¹, where R¹ is a linear or branched C²-C⁸ alkyl, and mixtures thereof, comprising from 10 to 40% by weight of units deriving from the alpha-olefin, based on the weight of (A4.2),
wherein
the polypropylene composition (A4) comprises a total amount of from 0.1 to 40% by weight of units deriving from ethylene and the alpha-olefin based on the weight of (A4), and
the amounts of (A4.1) and (A4.2) are based on the total weight of (A4.1)+(A4.2); and
(A5) mixtures thereof.

3. The covering for a light-source according to claim 1, wherein propylene copolymer (A) is selected from the group consisting of:
(A1a)propylene-ethylene-butene-1 terpolymers comprising from 0.5 to 1.8% by weight of units deriving from ethylene, based on the weight of component (A1a), and from 3.5 to 6.5% by weight of units deriving from butene-1, based on the weight of (A1a), wherein the propylene-ethylene-butene-1 terpolymer has a property selected from the following properties:
a total amount of units deriving from ethylene and butene-1 ranging from 5.5 to 7.5% by weight, based on the weight of (A1a); or
a melt flow rate measured according to ISO 1133 (230° C., 2.16 Kg) ranging from 20 to 80 g/10 min.; or
a xylene soluble fraction lower than 7.0% by weight, based on the weight of (A1a); and/or
a melting point equal to or higher than 140° C.;
(A4a)polyolefin compositions comprising:
(A4.1a) 55-80% by weight of a propylene polymer selected from the group consisting of propylene homopolymers, propylene copolymers with ethylene or an alpha-olefin of formula CH₂═CHR¹, where R¹ is a linear or branched C²-C⁸ alkyl, and mixtures thereof,
wherein the copolymer comprising from 0.1 to 10% by weight, of units deriving from ethylene or the alpha-olefin, based on the weight of (A4.1a), and
wherein the propylene polymer (A4.1a) has a melt flow rate measured according to ISO 1133 (230° C., 2.16 Kg) from 15 g/10 min. to 80 g/10. min.;
(A4.2a) 20-45% by weight of a copolymer of ethylene with an alpha-olefin of formula CH₂═CHR¹, where R¹ is a linear or branched C²-C⁸ alkyl, comprising from 10 to 40% by weight of units deriving from the alpha-olefin, based on the weight of (A4.2a);
wherein
the polypropylene composition (A4a) comprises a total amount of from 0.1 to 40% by weight of units deriving from ethylene and the alpha-olefin based on the weight of (A4a), and
the amounts of (A4.1a) and (A4.2a) are based on the total weight of (A4.1a)+(A4.2a); and
(A5a)mixtures thereof.

4. The covering for a light-source according to claim 1, wherein the elastomeric component (B) is a styrene block copolymer (B2) selected from the group consisting of: polystyrene-polybutadiene-polystyrene (SBS), polystyrene-poly(ethylene-butylene)-polystyrene (SEBS), polystyrene-poly(ethylene-propylene)-polystyrene (SEPS), polystyrene-polyisoprene-polystyrene (SIS), polystyrene-poly(isoprene-butadiene)-polystyrene (SIBS), and mixtures thereof.

5. The covering for a light-source according to claim 1, wherein the glass fibers (C) have a diameter ranging from 5 to 20 μm, and a length ranging from 0.1 to 10 mm.

6. The covering for a light-source according to claim 1, wherein the compatibilizer (D) is a polyolefin functionalized with a compound selected from the group consisting of maleic anhydride, C¹-C¹⁰ linear or branched dialkyl maleates, C¹-C¹⁰ linear or branched dialkyl fumarates, itaconic anhydride, C¹-C¹⁰ linear or branched itaconic acid, dialkyl esters, maleic acid, fumaric acid, itaconic acid, and mixtures thereof.

7. The covering for a light-source according to claim 1, wherein R¹ is selected from the group consisting of butene-1, hexene-1, 4-methyl-1-pentene, octene-1, and combinations thereof, preferably butene 1.

8. A polyolefin composition comprising:
(A) 50-80% by weight of a propylene copolymer selected from the group consisting of:
(A1) propylene copolymers with ethylene or an alpha-olefin of formula CH₂═CHR¹, where R¹ is a linear or branched C²-C⁸ alkyl, comprising from 0.1 to 8.5% by weight of units deriving from ethylene or the alpha-olefin, based on the weight of (A1);
(A2) polypropylene compositions comprising:
(A2.1) 25-65% by weight of a propylene homopolymer or a propylene copolymer with ethylene or an alpha-olefin of formula CH₂═CHR¹, where R¹ is a linear or branched C²-C⁸ alkyl,
wherein the copolymer comprising from 0.1 to 2% by weight of units deriving from ethylene or the alpha-olefin, based on the weight of (A2.1); and
(A2.2) 35-75% by weight of a propylene copolymer with ethylene or an alpha-olefin of formula CH₂═CHR¹, where R¹ is a linear or branched C²-C⁸ alkyl, comprising from 0.1 to 15% by weight, of units deriving from ethylene or the alpha-olefin, based on the weight of (A2.2), wherein the amounts of (A2.1) and (A2.2) are based on the total weight of (A2.1)+(A2.2);
(A4) polypropylene compositions comprising:
(A4.1) 55-80% by weight of a propylene polymer selected from the group consisting of propylene homopolymers, propylene copolymers with ethylene or an alpha-olefin of formula CH₂═CHR¹, where R¹ is a linear or branched C²-C⁸ alkyl, and mixtures thereof,
wherein the copolymer comprising from 0.1 to 10% by weight of units deriving from ethylene or the alpha-olefin, based on the weight of (A4.1);
(A4.2) 20-45% by weight of a copolymer of ethylene with an alpha-olefin of formula CH₂═CHR¹, where R¹ is a linear or branched C²-C⁸ alkyl, and mixtures thereof, comprising from 10 to 40% by weight of units deriving from the alpha-olefin, based on the weight of (A4.2).
wherein
the polypropylene composition (A4) comprises from 0.1 to 40% by weight of units deriving from the alpha-olefin, based on the weight of (A4), and
the amounts of (A4.1) and (A4.2) are based on the total weight of (A4.1)+(A4.2); and
(A5) mixtures thereof;
(B) 15-35% by weight of a saturated or unsaturated styrene or alpha-methylstyrene block copolymer, wherein the styrene block copolymer comprises from 10 to 30% by weight of polystyrene, based on the weight of component (B2);
(C) 5-30% by weight of glass fibers, and
(D) −0-5.0% by weight of a compatibilizer,
wherein the amounts of (A), (B), (C), and (D) are based on the total weight of (A)+(B)+(C)+(D), the total weight being 100%.

9. The polyolefin composition according to claim 8, wherein the propylene copolymer (A) is selected from the group consisting of:
(A1a)propylene-ethylene-butene-1 terpolymers comprising from 0.5 to 1.8% by weight of units deriving from ethylene, based on the weight of component (A1a), and from 3.5 to 6.5% by weight of units deriving from butene-1, based on the weight of (A1a), wherein the propylene-ethylene-butene-1 terpolymer has a property selected from the following properties:
a total amount of units deriving from ethylene and butene-1 ranging from 5.5 to 7.5% by weight, based on the weight of (A1a); or
a melt flow rate measured according to ISO 1133 (230° C., 2.16 Kg) ranging from 20 to 80 g/10 min.; or
a xylene soluble fraction lower than 7.0% by weight, based on the weight of (A1a);
or
a melting point equal to or higher than 140° C.;
(A4a)polyolefin compositions comprising:
(A4.1a) 55-80% by weight of a propylene polymer selected from the group consisting of propylene homopolymers, propylene copolymers with ethylene or an alpha-olefin of formula CH₂═CHR¹, where R¹ is a linear or branched C²-C⁸ alkyl, and mixtures thereof,
wherein the copolymer comprising from 0.1 to 10% by weight of units deriving from ethylene or the alpha-olefin, based on the weight of (A4.1a), and
wherein the propylene polymer (A4.1a) has a melt flow rate measured according to ISO 1133 (230° C., 2.16 Kg) from 15 g/10 min. to 80 g/10. min.;
(A4.2a) 20-45% by weight of a copolymer of ethylene with an alpha-olefin of formula CH₂═CHR¹, where R¹ is a linear or branched C²-C⁸ alkyl, comprising from 10 to 40% by weight of units deriving from the alpha-olefin, based on the weight of (A4.2a);
wherein
the polypropylene composition (A4a) comprises a total amount of from 0.1 to 40% by weight of units deriving from ethylene and the alpha-olefin based on the weight of (A4a), and
the amounts of (A4.1a) and (A4.2a) are based on the total weight of (A4.1a)+(A4.2a); and
(A5a)mixtures thereof.

10. The polyolefin composition according to claim 8, wherein the elastomeric component (B) is a styrene block copolymer (B2) is-selected from the group consisting of: polystyrene-polybutadiene-polystyrene (SBS), polystyrene-poly(ethylene-butylene)-polystyrene (SEBS), polystyrene-poly(ethylene-propylene)-polystyrene (SEPS), polystyrene-polyisoprene-polystyrene (SIS), polystyrene-poly(isoprene-butadiene)-polystyrene (SIBS), and mixtures thereof, preferably the styrene block copolymer (B2) is polystyrene poly(ethylene butylene) polystyrene (SEBS).

11. The polyolefin composition according to claim 8, wherein the glass fibers (C) have a diameter ranging from 5 to 20 μm; and a length ranging from 0.1 to 10 mm.

12. The polyolefin composition according to claim 8, wherein the compatibilizer (D) is a polyolefin functionalized with a compound selected from the group consisting of maleic anhydride, C¹-C¹⁰ linear or branched dialkyl maleates, C¹-C¹⁰ linear or branched dialkyl fumarates, itaconic anhydride, C¹-C¹⁰ linear or branched itaconic acid, dialkyl esters, maleic acid, fumaric acid, itaconic acid, and mixtures thereof.

13. (canceled)

14. A process for manufacturing a covering for a light-source comprising the step of shaping the covering from the polyolefin composition as of claim 1.

15. The process according to claim 14, wherein shaping is selected from the group consisting of injection molding, cast extruding, profile extruding, rotational molding, blow molding, and deep drawing.
